(19) United States
(12) Patent Application Publication
(10) Pub. No.: US 2024/0326075 A1
(43) Pub. Date: Oct. 3, 2024

(54) Flow Adjustment Valve For Sprinkler

(71) Applicant: Rain Bird Corporation, Azusa, CA (US)

(72) Inventors: Steven David Geerligs, Tucson, AZ (US); Michael A. McAfee, Tucson, AZ (US); Suzanne Marie Schneider, Corona de Tucson, AZ (US); Jiangjiang Dai, Tucson, AZ (US)

(21) Appl. No.: 18/194,154

(22) Filed: Mar. 31, 2023

(51) Int. Cl. B05B 12/00; B05B 3/04; B05B 15/625

(52) U.S. Cl. CPC B05B 12/002; B05B 3/0422; B05B 15/625

(57) ABSTRACT

A sprinkler that includes an internal flow adjustment valve is provided. The valve enables an operator of the sprinkler to selectively shut off, turn back on, or adjust the flow of water through the sprinkler while a riser of the sprinkler is in its extended position. The valve includes a valve seat disposed on an internal flow tube and a valve plunger having an actuation shaft and a throttle nut. An outboard end of the actuation shaft can be accessed and rotated at a riser cap, which causes vertical movement of the valve plunger as threads on an inboard end of the actuation shaft engage a threaded passage disposed in the internal flow tube. Vertical movement of the valve plunger causes movement of the throttle nut relative to the valve seat and opening and closing of the valve. The throttle nut and the valve seat may have corresponding dual helical surfaces.

### TECHNICAL FIELD

The technical field relates to irrigation sprinklers and, more specifically, to sprinklers having internal valves for adjusting or turning off water flow to a sprinkler head.

### BACKGROUND

Sprinklers are commonly used for irrigating residential and commercial lawns, golf courses, athletic fields, agricultural fields, and other vegetation. Pop-up irrigation sprinklers are commonly used in irrigation systems where it is necessary or desirable to embed the sprinkler in the ground so that it does not project appreciably above ground level when not in use. In a typical pop-up sprinkler, a tubular riser is mounted within a generally cylindrical upright sprinkler housing or case having an open upper end, with a spray head carrying one or more spray nozzles mounted at an upper end of the riser.

Sprinklers often use replaceable nozzles wherein different nozzles may be selected and mounted in the sprinkler to achieve a specific range or rate of coverage. To optimize irrigation for a given area or zone, it is sometimes necessary or desirable to change or adjust nozzles or other features of a sprinkler unit. Replacing a nozzle, or otherwise adjusting or conducting maintenance on a sprinkler, normally requires shutting off the irrigation system in its entirety. To prevent the operator from needing to walk back and forth between the control valve and the sprinkler units, it is desirable to be able to selectively shut off the flow at the individual sprinkler. It is particularly convenient to shut off the flow when the sprinkler unit is in its extended position to better enable access to the unit.

Beyond shutting off the flow and turning the flow back on, it is also desirable to be able to selectively adjust the flow of water at the sprinkler unit, for instance, to adjust the flow rate and the water radius (i.e., the distance the water is thrown from the sprinkler), especially if the system is being operated at higher than normal pressures. Adjusting both the flow rate and water radius can help target certain areas of terrain and prevent common issues such as misting, overwatering, or application to non-vegetation areas (e.g., sidewalks, streets, or driveways).

### BRIEF DESCRIPTION OF THE DRAWINGS

FIG. 1 is a top perspective view of a sprinkler.

FIG. 2 is a cross-section view of the sprinkler of FIG. 1.

FIG. 3 is an enlarged cross-section view of a portion of the sprinkler of FIG. 1.

FIG. 4A is a perspective view of a nozzle plug of the sprinkler of FIG. 1.

FIG. 4B is a cross-section view of the nozzle plug of FIG. 4A taken along line 4B-4B of FIG. 4A.

FIG. 5A is a perspective view of a ring gear/flow tube assembly of the sprinkler of FIG. 1.

FIG. 5B is a cross-section view of the ring gear/flow tube assembly of FIG. 5A.

FIG. 6A is a top perspective view of a first flow tube of the ring gear/flow tube assembly of FIG. 5A.

FIG. 6B is a cross-section view of a second flow tube of the ring gear/flow tube assembly of FIG. 5A.

FIG. 7A is a top perspective view of a valve plunger of the sprinkler of FIG. 1.

FIG. 7B is a bottom perspective view of the valve plunger of the sprinkler of FIG. 1.

FIG. 7C is an additional top perspective view of the valve plunger of the sprinkler of FIG. 1.

FIG. 8A is an enlarged cross-section view of a portion of the sprinkler of FIG. 1 in a closed position of a flow adjustment valve.

FIG. 8B is an enlarged cross-section view of a portion of the sprinkler of FIG. 1 in an open position of the flow adjustment valve.

FIG. 9A is a left side perspective view of a portion of the flow adjustment valve of the sprinkler of FIG. 1 in a closed position of the flow adjustment valve.

FIG. 9B is a left side perspective view of a portion of the flow adjustment valve of the sprinkler of FIG. 1 in a position of the flow adjustment valve.

FIG. 9C is a right side perspective view of the flow adjustment valve of the sprinkler of FIG. 1 in the position of FIG. 9B.

FIG. 9D is a left side perspective view of the flow adjustment valve of the sprinkler of FIG. 1 in an alternative position of the flow adjustment valve.

FIG. 9E is a left side perspective view of the flow adjustment valve of the sprinkler of FIG. 1 in an alternative position of the flow adjustment valve.

### DETAILED DESCRIPTION

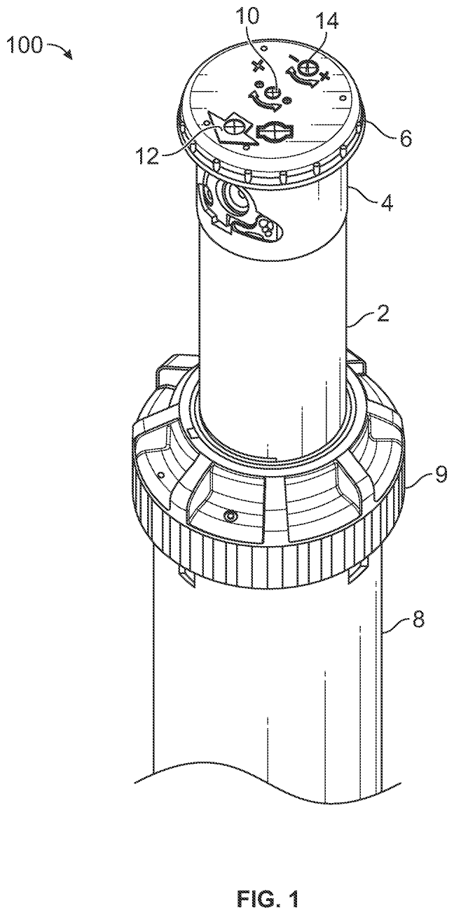

As shown generally in FIGS. 1-3, there is an exemplary pop-up rotor sprinkler 100 having an internal flow adjustment valve 70. The flow adjustment valve 70 enables an operator of the sprinkler 100 to selectively shut off, turn back on, or adjust the flow of water through the sprinkler 100 at the sprinkler, including while the sprinkler 100 is in its extended (“popped-up”) position.

The rotor sprinkler 100 generally comprises a main housing or case 8 having an inlet 3 for receiving water; a riser 2 including a plurality of components for managing water pressure, arc travel and limits, and facilitating a desired spray pattern; and a nozzle 7 (e.g., grid main nozzle) coupled to and disposed within a nozzle socket 5 of a nozzle housing or turret 4 for discharging pressurized water. The nozzle housing 4 is coupled to the riser 2 at a distal end away from the case 8. The riser 2 extends from the case 8 when water is turned on and retracts in the case 8 using a retraction spring 16 when the water is turned off. Additional examples of rotor sprinklers may be found in U.S. Pat. Nos. 4,787,558; 5,383,600; and 6,732,950, and in U.S. application Ser. No. 17/694,948, filed Mar. 15, 2022, and Ser. No. 17/975,345, filed Oct. 27, 2022, which are incorporated herein by reference in their entirety.

The case 8 generally has an elongated cylindrical configuration formed typically from a lightweight injection molded plastic. The inlet 3 may be formed at one end of the case 8 and receives pressurized water for irrigation through a designated threaded coupling. An opposite end of the case 8 may be configured (e.g., threaded) to accommodate mounting of a cover 9. The riser 2 is generally configured as an elongated hollow tube having a size and shape configured for slide-fit through the cover 9 and a wiper seal 9a and reception into the interior of the case 8. The riser 2 may also be constructed from a lightweight injection molded plastic.

A retraction spring 16 sits between the inside of the cover 9 of the case 8 and a bottom of the riser 2. In operation, the water pressure overrides the force of the spring 16, compresses the spring 16, and extends the riser 2 for irrigation. When the water is turned off, the spring 16 expands and urges the riser 2 into a retracted position into the interior of the case 8. Further, when the riser 2 is in a retracted position, a riser cap 6 (e.g., a turret assembly cover) of the nozzle housing 4 rests against an upper portion of the cover 9 to aide in keeping debris from entering into the case 8.

As water passes through the sprinkler 100, it also passes through a turbine regulator module 18, for effective water use by the sprinkler 100. The turbine regulator module 18 may also include a filter 15 for preventing debris from entering the main flow of the sprinkler 100. A gear reduction mechanism 20 is disposed in the riser 2 downstream of the turbine regulator module 18 and reduces the speed of the turbine to drive rotation of the turret 4 at a target speed (e.g., 1 rpm) for discharging water through the nozzle 7. An arc setting mechanism 23 is disposed within the turret 4 and riser 2 downstream of the gear reduction mechanism 20 which enables setting of an arc of rotation of the turret 4. An operator may set or adjust the arc via an arc adjustment access point 14 on the riser cap 6 which rotates an arc adjustment shaft 23a operatively coupled to the arc setting mechanism 23. For instance, the arc setting mechanism may be adjusted to a part-circle mode (less than 360° arc coverage) or a full-circle mode (360° arc coverage). The components of the arc setting mechanism 23 work in cooperation with the gear reduction mechanism 20 to rotate the turret 4 to dispense water through the nozzle 7 for irrigation over a selected target terrain area.

The riser cap 6 also includes an access point 12 for installation of a nozzle retaining radius reduction screw (also called a break-up screw) through a threaded screw socket 13 positioned above and in front of the nozzle 7. Insertion of the radius reduction screw provides retention of the nozzle and moves the screw into the path of outgoing water to allow refinement or reduction of the sprinkler's water radius.

An access point 10 is also centrally positioned on the riser cap 6 for adjusting the flow adjustment valve 70. Specifically, the flow adjustment valve 70 is actuated via a valve plunger 71 having an elongated actuation shaft or stem 73. The actuation shaft 73 is accessible through the access point 10 and configured to be manually turned by a tool, such as a screwdriver, to open and close the valve 70. More specifically, turning the actuation shaft 73 results in axial and rotational movement of the valve plunger 71 along a central axis 60 of the sprinkler, which moves a throttle nut or valve body 72 of the valve plunger 71 relative to a valve seat 45, as described in further detail below. Indicia adjacent the access point 10 may be included to indicate to a user a direction of rotation for either opening or closing the valve 70 and/or for increasing or reducing flow and pressure through the valve 70.

During operation, after water passes through the filter 15 and the turbine regulator module 18, water is communicated downstream through a ring gear/flow tube assembly 50 of the arc setting mechanism 23. In an open state of the flow adjustment valve 70, water passes from a first flow tube 40 (e.g., a lower flow tube) to a second flow tube 55 (e.g., an upper flow tube) of the ring gear/flow tube assembly 50. Water is then communicated from the second flow tube 55 to a flow passage 25 of the nozzle housing 4 before being discharged from the sprinkler 100. The flow passage 25 is defined by an upstream portion 25a axially aligned with and coupled to the second flow tube 55 and an elbow portion 25b configured to feed the backside entrance of the nozzle socket 5 and nozzle 7 to discharge water radially from the sprinkler 100. The elbow portion 25b of the flow passage 25 is defined at least in part by a nozzle plug 30 disposed in an opening 28 of the nozzle housing 4.

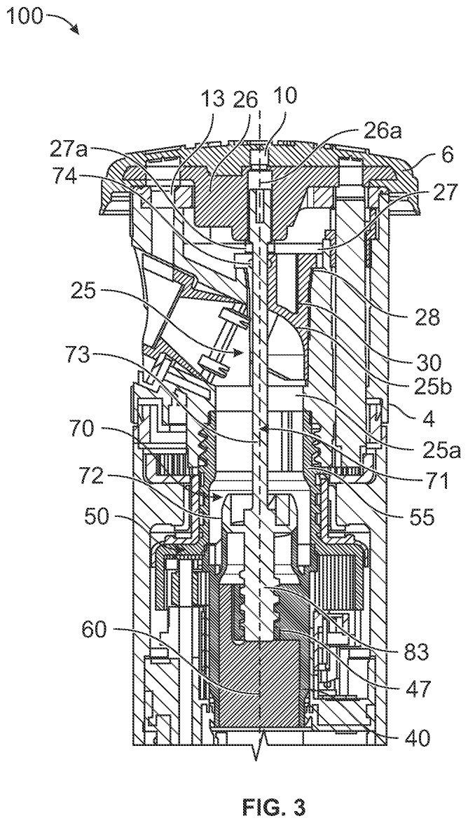

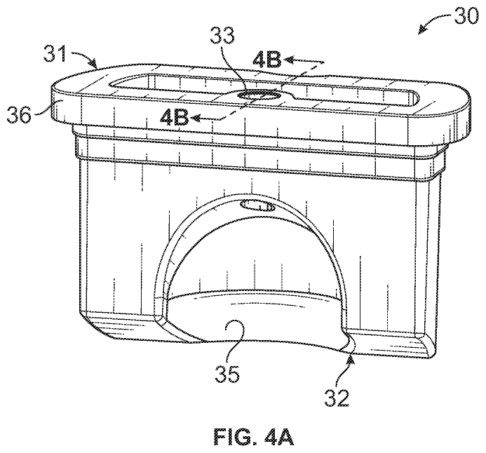

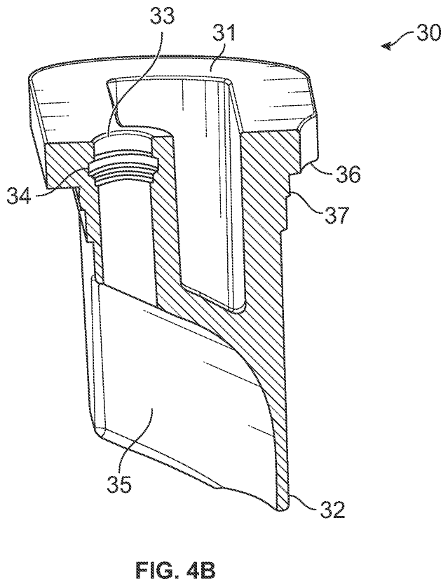

With reference to FIGS. 3-4B, the nozzle plug 30 is shaped and sized to closely fit in the opening 28 of the nozzle housing 4. For example, the nozzle plug 30 may be welded to the nozzle housing 4, though other conventional methods of attachment (e.g., gluing) are contemplated. A first end 31 includes a flange 36 which seats on the nozzle housing 4 surrounding the opening 28 after the nozzle plug 30 is welded into place. A stepped surface 37 adjacent the flange 36 is configured to mate with a complementary structure on the nozzle housing 4.

A second end 32 of the nozzle plug 30 is partially cored out to define the elbow portion 25b in the flow passage 25. The nozzle plug 30 further defines a passage 33 extending from the first end 31 to the coring 35, which allows the actuation shaft 73 of the flow adjustment valve 70 to extend from the riser cap 6 through the nozzle plug 30 into the flow passage 25 of the nozzle housing 4. The passage 33 may be sized to closely fit around the actuation shaft 73, while still allowing ease of rotation and vertical movement of the actuation shaft 73 relative to the passage 33. The passage 33 may include a groove 34 for an o-ring seal 74 or a custom-formed lip seal that seals the passage 33 with the actuation shaft 73 installed.

With reference to FIGS. 3 and 5A-6B, the ring gear/flow tube assembly 50 includes the first flow tube 40 and the second flow tube 55, which is downstream of the first flow tube 40. The flow tubes 40 and 55 are axially aligned and together form a flow path along the central axis 60 of the sprinkler 100. While the flow tubes 40 and 55 are illustrated as distinct components that are coupled together (e.g., welded), it is also contemplated that the flow tubes 40 and 55 can be formed integrally as a single component.

The first flow tube 40 includes an upstream portion 42 and a downstream valve portion 43 which extend along the central axis 60. The valve portion 43 has a reduced outer and inner diameter relative to the upstream portion 42 and projects concentrically into the second flow tube 55. The valve portion 43 terminates in a valve seat 45 for the flow adjustment valve 70. There may be a gradual transition (e.g., an angled segment 42a) between the diameter of the upstream portion 42 and the reduced diameter of the valve portion 43 to create a smooth transition for water flow through the flow path. The angled segment 42a is angled radially inward in a downstream direction and centers the valve portion 43 with respect to the upstream portion 42.

A flange 51 extends radially about the first flow tube 40 from the upstream portion 42 at the transition between the upstream portion 42 and the valve portion 43 (e.g., adjacent the angled segment 42a). An annular wall 52 extends axially from the perimeter of the flange 51 and spaced concentrically about the valve portion 43. The valve portion 43 is supported concentrically to the wall 52 with ribs 44. The illustrated embodiment includes four ribs 44 equally spaced about the valve portion 43, though other numbers of ribs are possible.

The wall 52 includes an annular step 52a. The wall 52 is axially aligned with a wall 57 at the first end 57a of the second flow tube 55 and the annular step 52a (e.g., a male step) engages a complementary annular step 58 (e.g., a female step) on the wall 57. The complementary annular steps 52a, 58 may be welded together to sealingly couple the first flow tube 40 to the second flow tube 55.

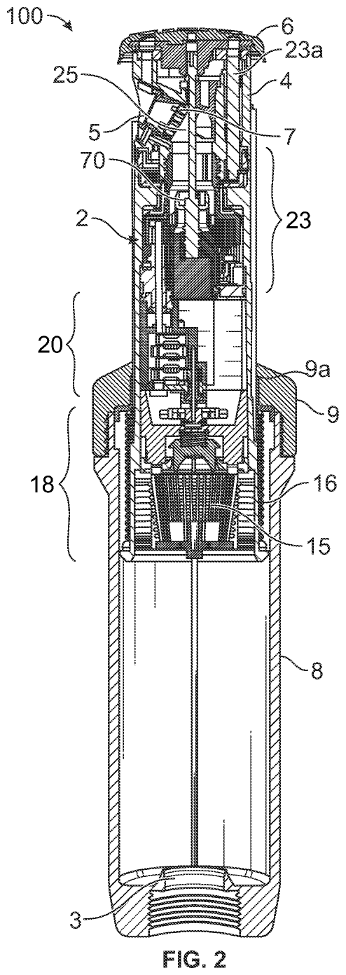

The second flow tube 55 has a first portion 56a that has a larger inner diameter than a second, downstream portion 56b. The wall 57 at the first portion 56a is thinner than the second portion 56b. The larger inner diameter of the first portion 56a provides extra space from the flow adjustment valve 70 to reduce pressure loss and smoothly transition flow when water passes through the valve seat 45 and then the second flow tube 55. The wall 57 may be configured for a gradual or smooth transition 56c from the first portion 56a to the second portion 56b, which may have an inner diameter substantially the same as that of the upstream portion 42 of the first flow tube 40 and of the upstream portion 25a of the nozzle housing flow passage 25. The second portion 56b and a second end 57a of the second flow tube 55 are coupled (e.g., through threading 57c) to the nozzle housing 4, forming a continuous flow path between the second flow tube 55 and the nozzle housing flow passage 25. A ring gear element 59 for the arc setting mechanism 23 (FIG. 2) may extend integrally from the first end 57a of the second flow tube 55.

The first flow tube 40 further includes a central threaded passage 47 within the upstream portion 42. The threaded passage 47 is supported concentrically to the upstream portion 42 with spokes 49. The threaded passage 47 has internal threading 48 and is sized to receive and cooperate with external threading 84 on a guide shaft 83 of the valve plunger 71, as described further below. The threaded passage 47 has a smaller diameter than the valve portion 43 and extends axially within the upstream portion 42 just upstream of the valve portion 43.

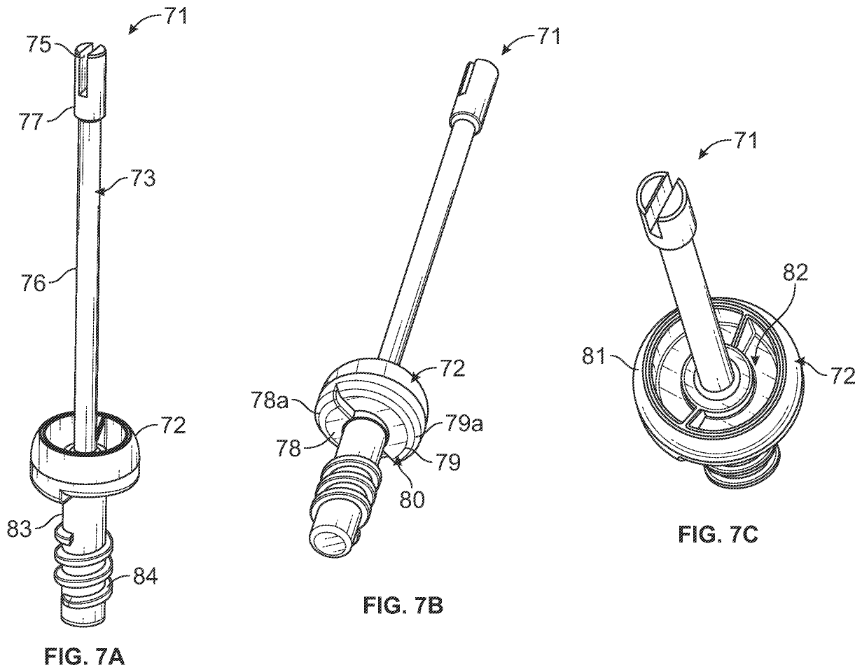

As described above, the valve portion 43 projects or protrudes into the second flow tube 55 and defines the valve seat 45. The valve seat 45 includes two interior helical surfaces 46a, 46b that correspond to two exterior helical surfaces 78, 79 on the throttle nut 72 (FIG. 7B). Specifically, the helical surfaces 46a, 46b are chamfered radially inwardly to engage corresponding exterior chamfered edges 78a, 79a of the two exterior helical surfaces 78, 79 of the throttle nut (FIG. 7B). Each helical surface 46a, 46b of the valve seat 45 is oriented with a downstream end (or top) of one helical surface 46a, 46b adjoining an upstream portion (or bottom) of the other helical surface 46a, 46b. The helical surfaces 46a, 46b have the same pitch and also have the same pitch as the threads 48 of the threaded passage 47. While the illustrated configuration includes two helical surfaces, it is also contemplated that a different number or arrangement of helical surfaces (e.g., a single helical surface) and corresponding helical surfaces may be used for the valve seat 45 and the throttle nut 72. Further, instead of helical profiles, the valve seat 45 and corresponding surface on the throttle nut 72 may be uniform flat surfaces.

With reference to FIGS. 3 and FIGS. 7A-8B, the valve plunger 71 includes the throttle nut 72, the actuation shaft 73, and the guide shaft 83. The actuation shaft 73 includes an outboard portion 77 that is accessible via the access point 10 on the riser cap 6, as discussed above. Specifically, the outboard portion 77 is received and configured to move axially within a passage 26a of a cap insert 26 (e.g., an overmolded cap insert) adjacent the riser cap 6. The outboard portion 77 is configured to be turned by a tool (e.g., includes a recess 75 to be manually turned by a screwdriver). The outboard portion 77 may seat on a flexible seal insert 27 (e.g., a foam insert) between the cap insert 26 and the nozzle plug 30 when the shaft 73 has been turned to a fully closed position of the valve 70. A main portion 76 of the shaft 73 extends through a hole 27a of the seal insert 27, the passage 33 of the nozzle plug, the nozzle housing flow passage 25, and the second flow tube 55 towards the valve seat 45.

The throttle nut 72 is positioned at a transition from the main portion 76 of the actuation shaft 73 to the guide shaft 83. The guide shaft 83 is axially aligned with the actuation shaft 83 and is threadingly received within the central threaded passage 47 of the first flow tube 40. The guide shaft 83 includes external threading 84, which cooperates with the internal threading 48 of the threaded passage 47. Rotation of the actuation shaft 73 at the access point 10 (e.g., by a tool) drives axial movement of the valve plunger 71 as the external threading 84 on the guide shaft 83 engage the internal threading 48 of the threaded passage 47. This movement correspondingly results in axial and rotational movement of the throttle nut 72 relative to the valve seat 45 to open and close the valve 70.

The valve plunger 71 may be a single piece construction. That is, the throttle nut 72, the actuation shaft 73, and the guide shaft 83 may be formed integrally. By another approach, the valve plunger 71 may comprise two or more pieces. For example, the throttle nut 72 and the actuation shaft 73 may be separate components that are coupled together, for example by welding or by threading the actuation shaft 73 into a central threaded bore of the throttle nut 72. The guide shaft 83 may also be a separate component coupled to the other components or may be integrally formed with the throttle nut 72 or the actuation shaft 73. For instance, the guide shaft 83 may extend upwardly through the throttle nut and receive the actuation shaft 73.

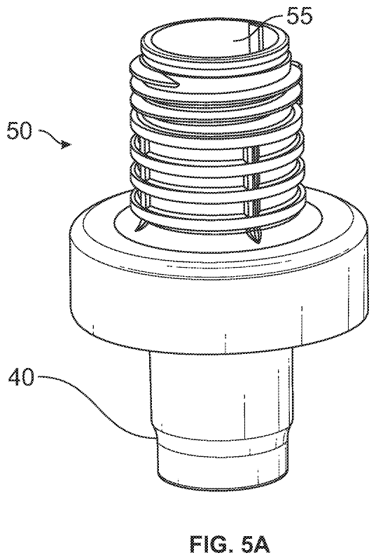

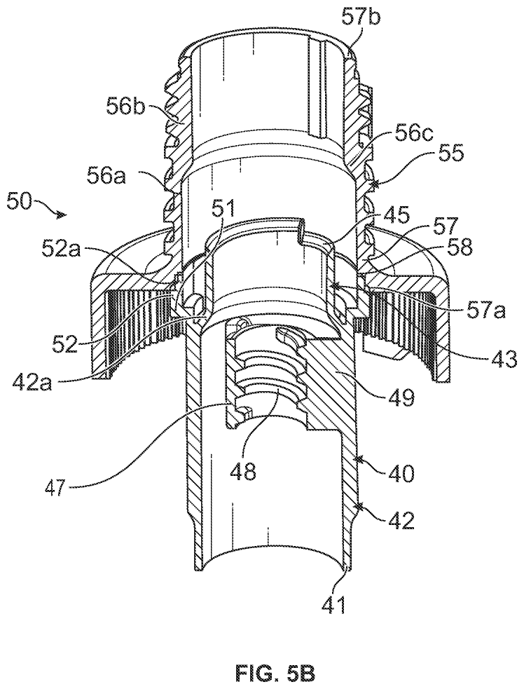

The throttle nut 72 includes a bottom 80 that extends radially at the interface between the actuation shaft 73 and the guide shaft 83. An annular side wall 81 extends axially from the bottom 80 toward the main portion 76 of the actuation shaft 73 and defines an annular recess 82 between the main portion 76 and the side wall 81. The side wall 81 may have a profile that curves or tapers radially inwards towards the actuation shaft 73 to minimize turbulence of the water flow as it travels downstream of the throttle nut 72 from the first portion 56a of the second flow tube 55 to the second portion 56b of the second flow tube 55 (FIG. 5B). For example, the curve or taper of the side wall 81 may follow a curve or taper of the wall 57 of the second flow tube 55 at the transition 56c between the expanded inner diameter of the first portion 56a and the smaller inner diameter of the second portion 56b of the second flow tube 55 (FIG. 5B). This permits a smoother water path and less pressure loss.

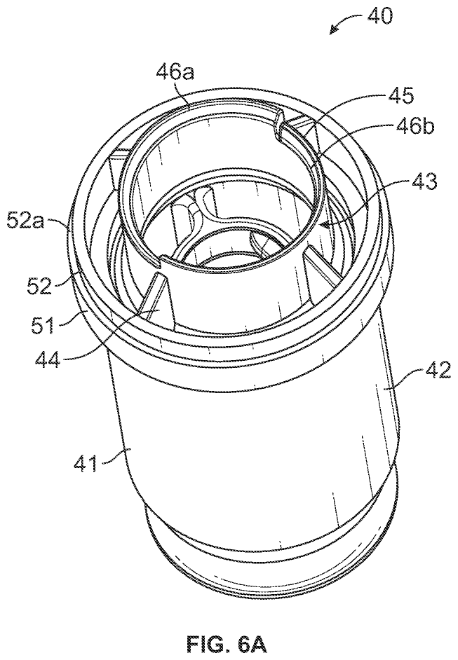

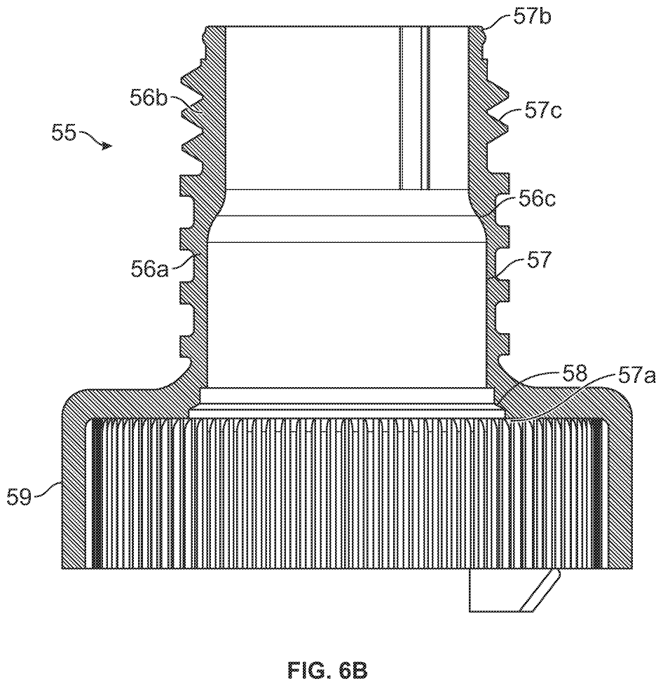

The bottom 80 includes the first helical surface 78 and the second helical surface 79 that correspond to the helical surfaces 46a, 46b (FIG. 6) on the valve seat 45. The helical surfaces 78, 79, helical surfaces 46a, 46b (FIG. 6), internal threading 48 (FIG. 5A), and external threading 84 all have the same pitch. Similar to helical surfaces 46a, 46b, the helical surfaces 78, 79 are oriented such that the top of one helical surface (e.g., 78) adjoins the bottom of the other helical surface (e.g., 79). The first helical surface 78 and the second helical surface 79 include a first chamfered helical edge 78a and a second chamfered helical edge 79a, respectively, where each surface meets the side wall 81.

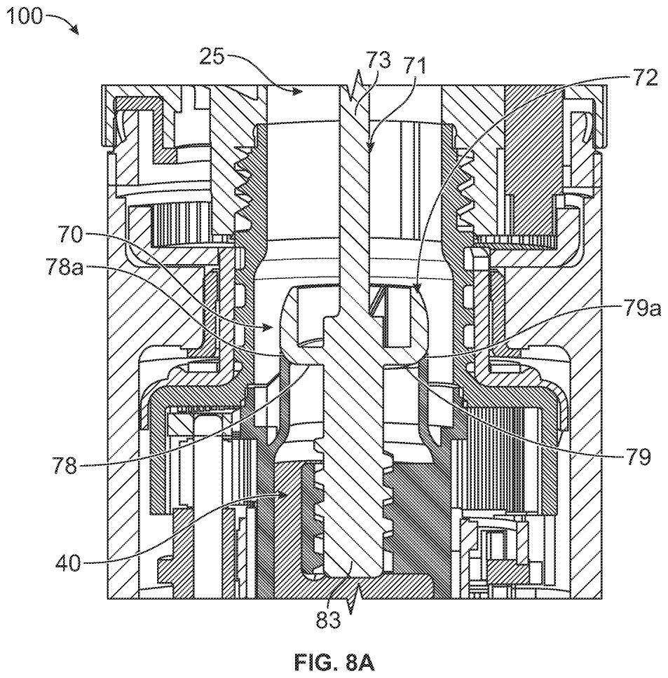

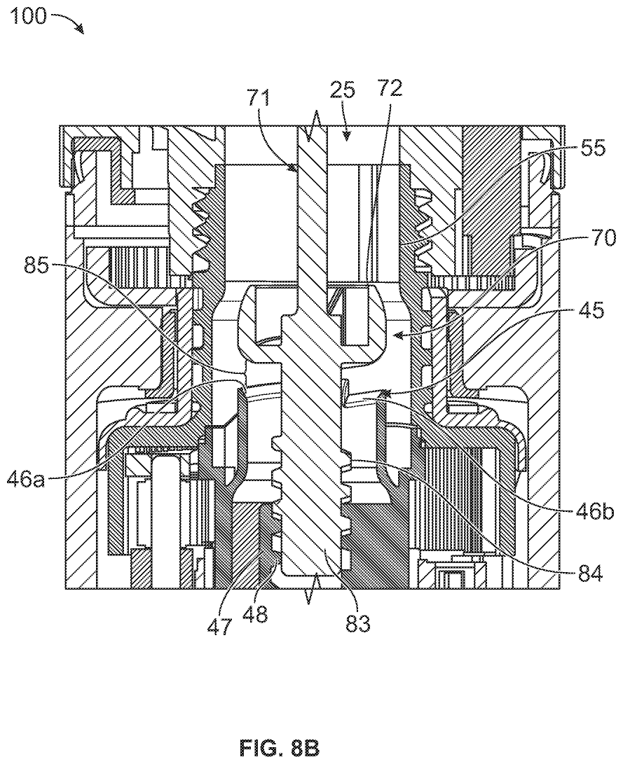

With reference to FIGS. 8A and 8B, when the valve plunger 71 is moved into a completely closed position of the flow adjustment valve 70, the chamfered helical edges 78a, 79a of the throttle nut 72 have an interference fit with the corresponding helical surfaces 46a, 46b of the valve seat 45, inhibiting flow of water from the first flow tube 40 to the second flow tube 55 and nozzle housing flow passage 25 so that the sprinkler 100 cannot discharge water. Specifically, when the actuation shaft 73 is rotated clockwise to close the valve 70, the throttle nut 72 axially moves towards the valve seat 45 due to cooperation between the threading 84 on the guide shaft 83 and the threading 48 on the threaded passage 47 of the first flow tube 40. The throttle nut 72 also rotates relative to the valve seat 45. The valve 70 is configured so that the axial and rotational movement of the throttle nut 72 relative to the valve seat 45 results in interference sealing of the corresponding helical portions 46a, 46b of the valve seat 45 and the helical edges 78a, 79a of the throttle nut 72 when in the fully closed position.

In a fully open position of the flow adjustment valve 70 (e.g., as illustrated in FIG. 8B), the helical edges 78a, 79a of the throttle nut 72 are spaced from the valve seat 45 permitting flow of water from the first flow tube 40 to the second flow tube 55 and nozzle housing flow passage 25 so that the sprinkler 100 cannot discharge water. Specifically, when the actuation shaft 73 is rotated counterclockwise to open the valve 70, the throttle nut 72 rotates and moves axially relative to the valve seat 45, forming a slot or flow passage 85 between the valve seat 45 and the helical edges 78a, 79a of the throttle nut 72. In some embodiments, a fully open position may be defined when further axial movement is stopped by a portion of the actuation shaft 73 abutting a stop. For instance, in some embodiments the outboard portion 77 of the actuation shaft 73 may abut the cap insert 26 or riser cap 6. In other embodiments, a stop may be positioned along the main portion 76 of the actuation shaft 73. For example, the main portion 76 of the actuation shaft 73 may have a collar that abuts a stop adjacent the nozzle plug 30 or flow passage 25.

A fully open position provides a slot 85 between the throttle nut 72 and the valve seat 45 with a maximum cross-section, providing both a maximum flow rate and a maximum water radius of the water as it is discharged from the sprinkler 100.

In this manner, a user can manually shut off the flow to an individual sprinkler head as well as manually turn the flow back on. While shut off, users can advantageously conduct maintenance on a zone or replace nozzles without needing to use a control valve or a controller to turn off the sprinkler, all while the sprinkler riser 2 is in a pressurized and extended position.

Further, if an entire zone includes sprinklers having a flow adjustment valve 70, shutting off the flow of water through each of the sprinklers can allow for a lateral line to be flushed of trapped debris should a repair of the lateral line be required.

The flow adjustment valve 70 also can be adjusted to any position between a fully closed position and a fully open position. Thus, the flow of water through the sprinkler 100 can be throttled. Specifically, the size of the cross-section of the slot or flow passage 85 between the valve seat 45 and the throttle nut 72 corresponds to the amount of throttling of the water.

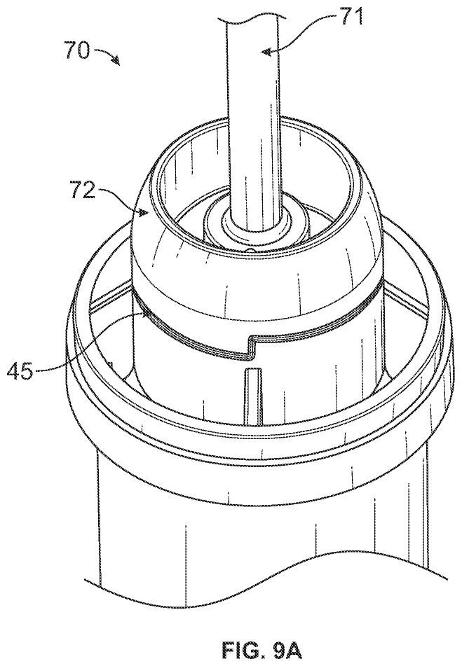

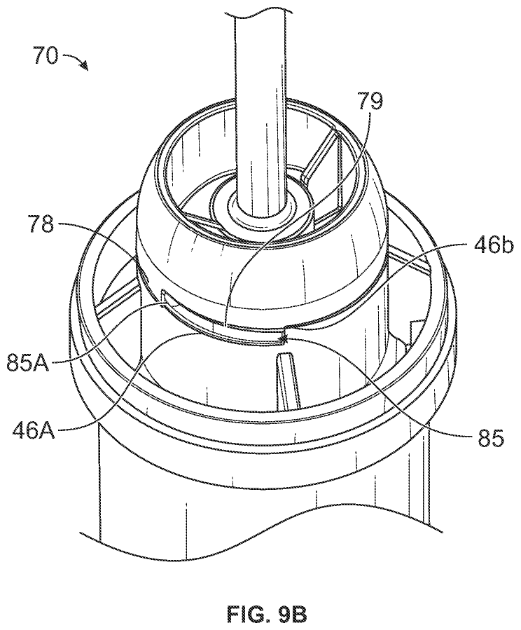

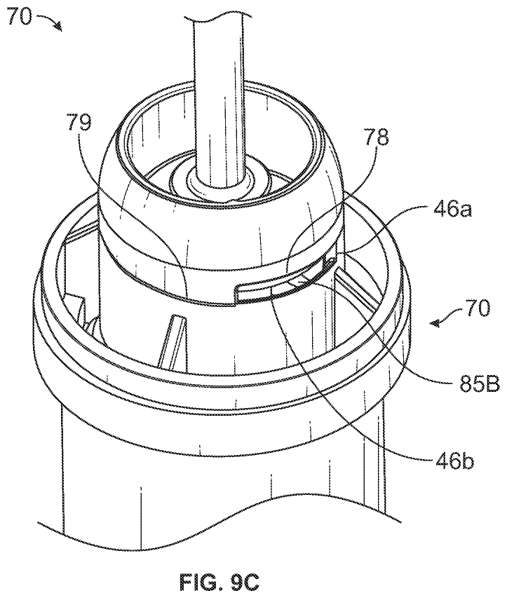

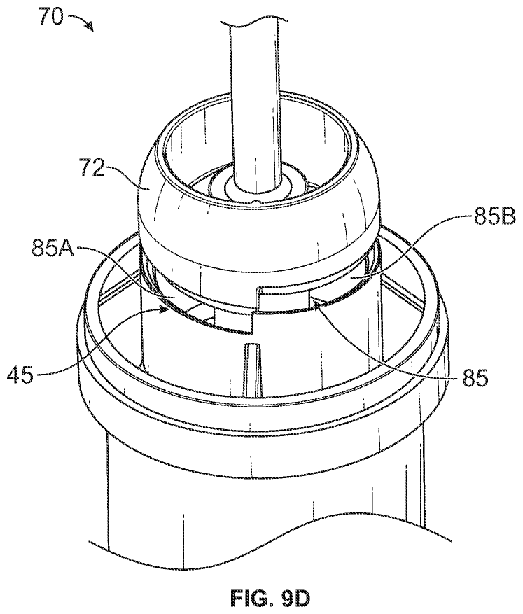

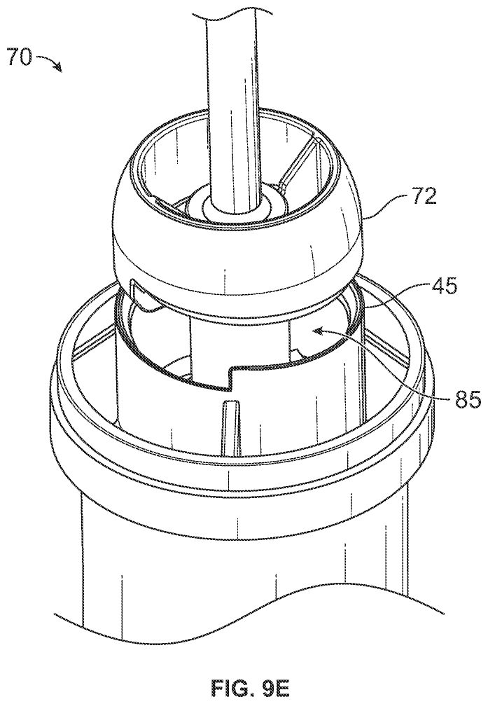

With reference to FIGS. 9A-9E, the dual helical configuration of the throttle nut 72 and valve seat 45 is advantageous for the throttling function of the valve 70. While FIG. 9A shows a completely closed position of the valve 70, FIGS. 9B-9E illustrate how the slot or flow passage 85 between the valve seat 45 and the throttle nut 72 is adjusted as the throttle nut 72 rotationally and axially moves relative to the valve seat 45.

For instance, a less than 180° turn of the actuation shaft 73 from the closed position results in the formation of a first window or slot 85A and an opposing second window or slot 85B. The first window 85A is defined by a gap between the second helical surface 79 of the throttle nut 72 and the first helical surface 46a of the valve seat 45 that forms when the first helical surface 78 of the throttle nut 72 is rotated away from sealing contact with the second helical surface 46b of the valve seat 45. The opposing second window 85B is defined by a gap between the first helical surface 78 of the throttle nut 72 and the second helical surface 46b of the valve seat 45 that forms when the second helical surface 79 of the throttle nut 72 is rotated away from sealing contact with the first helical surface 46a of the valve seat 45. When the rotation of the actuation shaft 73 from the closed position of the valve 70 is less than 180°, turning the actuation shaft 73 to open the valve causes the length of the windows 85A, 85B to increase while the width of the windows 85A, 85B is constant. A maximal length of each of the windows 85A. 85B occurs when the shaft 73 is turned to about 180°, as illustrated in FIG. 9D.

When the shaft 73 is turned beyond 180° from the closed position, for example as illustrated in FIG. 9E, a single continuous annular slot 85 is defined. Continued turning of the shaft 73 further increases the cross-section of the slot 85 as the throttle nut 72 is axially distanced from the valve seat 45.

In some embodiments, one full turn (i.e., 360°) of the actuation shaft 73 opens the valve sufficiently so there is no or minimal throttling effect on the flow or pressure of the water discharged from the sprinkler. A throttling effect may occur when the actuation shaft 73 is turned less than a full turn. For example, a 180° turn, by one approach, may result in pressure reduction of about 10%.

The above configuration allows for increased precision in throttling the valve 70 while reducing the number of turns of the actuation shaft 73 required to open and close the valve 70. In addition, compared to a flat configuration, at low flow settings when the throttle nut 72 is adjusted to a partially open position relative to the valve seat 45, a helical configuration provides a larger cross-section and width of the slot 85 formed between the valve seat 45 and the throttle nut 72. The larger cross-section and width helps prevent clogging of the flow adjustment valve 70 by particulate matter at low flow settings. Moreover, a dual helical configuration, which forms two opposing windows 85A, 85B when turned 180° or less from the closed position, permits an even, symmetric flow of water past the valve seat 45.

Throttling the sprinkler 100 using the flow adjustment valve 70 beneficially allows an operator to adjust both the flow rate and the water radius of the sprinkler (i.e., the distance the water is thrown). While a radius reduction screw can be used to reduce a sprinkler's water radius by moving the screw into the path of outgoing water, the screws do not reduce the flow rate of the water, which can result in overwatering of terrain close to the head of the sprinkler. In contrast, since partial closure of the flow adjustment valve 70 reduces both the flow rate and the water radius of the sprinkler 100, the risk of overwatering is significantly reduced.

In addition, throttling the flow can allow the operator to resolve other issues. For instance, when a sprinkler is experiencing pressure that is too high, misting may occur. Using the flow adjustment valve 70, a user can limit the flow to increase a pressure drop (e.g., from 90 to 70 psi) to reduce misting and permit more efficient operation. Partially closing the flow adjustment valve 70 to increase a pressure drop may also improve nozzle performance for specific nozzles.

The flow adjustment valve 70 and the ring gear/flow tube assembly 50 are configured to minimize flow disruptions or inefficiencies as water passes through the valve 70. For instance, the throttle nut 72 sealing on the perimeter of the valve portion 43 of the first flow tube 40, without any additional structural members or support ribs, prevents disruption to the flow that could affect distribution uniformity of the sprinkler 100. In addition, the placement of the valve 70 (i.e., the valve seat 45 and the throttle nut 72) within the first portion 56a of the second flow tube 55 allows a sufficient distance downstream of the valve 70 to assist in the remedy of flow disturbances prior to the flow entering the nozzle.

Further, the first flow tube 40 and the second flow tube 55 configured as two separate components welded together facilitates interior definition and fine-tuning of the valve features, which may reduce flow losses, and facilitates assembly. Specifically, the flow path through the tubes 40, 55 can be optimized in conjunction with the design of the throttle nut 72 to enhance laminar flow through the flow adjustment valve 70 and minimize pressure and flow loss. For instance, as discussed above, an expanded inner diameter of the first portion 56a of the second flow tube 55, a gradual transition 56c between the expanded inner diameter of the first portion 56a of the second flow tube 55 to the smaller inner diameter of the second portion 56b, and a curved side profile of the throttle nut 72 can permit a smoother flow path as the water flows downstream from the valve 70. The inner diameter of the valve portion 43 of the first flow tube 40 can also be selected relative to the inner diameters of the second flow tube 55 to reduce flow inefficiencies.

The throttle nut 72 can be made from any suitable plastic or metal that is resistant to water and chemicals commonly used in irrigation and has a high tensional strength or tensional modulus. By one approach, the material has good wear resistance for durability in a high-speed area of flow of the sprinkler 100. For example, the the throttle nut 72 (or the entire valve plunger 71) may be formed from a rigid polyurethane to minimize wear over time, particularly if the water source includes substantial particulate matter. In addition, the throttle nut 72 may be overmolded with a more flexible material (e.g., a thermoplastic elastomer material) to further facilitate sealing between the throttle nut 72 and the valve seat 45.

It will be understood that various changes in the details, materials, and arrangements of parts and components which have been described and illustrated above to explain the nature of the sprinkler may be made by those skilled in the art within the principle and scope of the sprinkler as expressed in the following claims. Furthermore, while various features have been described regarding a particular embodiment or a particular approach, the foregoing description and accompanying drawings is offered by way of illustration only and not as a limitation. Further, while embodiments have been shown and described, it will be apparent to those skilled in the art that modifications may be made to them without departing from the broader aspects of the technological contribution. The actual scope of the protection sought is defined in the following claims.

What is claimed is:

1. A sprinkler, comprising:
a sprinkler body;
a nozzle housing at a distal end of the sprinkler body for dispensing water from the sprinkler;
a water flow path through the sprinkler body and the nozzle housing defined at least in part by a first flow tube extending at least in part into a second flow tube; and
a valve along the flow path including:
a valve seat disposed on the first flow tube, and
a valve plunger movable from a closed position where the plunger prevents flow of water past the valve seat into the nozzle housing to an open position where the plunger is spaced from the valve seat permitting flow of water past the valve seat into the nozzle housing.

2. The sprinkler of claim 1, the valve plunger including an actuation shaft and a valve body extending from an inboard end of the actuation shaft, the valve body configured to sealingly engage the valve seat in the closed position.

3. The sprinkler of claim 2, the actuation shaft having an outboard end accessible through a cap of the nozzle housing that can be rotated to cause movement of the valve plunger along a central axis, the valve plunger further comprising a guide shaft comprising threading, the valve body disposed between the actuation shaft and the guide shaft.

4. The sprinkler of claim 3, wherein the guide shaft engages a threaded passage upstream of the valve seat within the first flow tube.

5. The sprinkler of claim 3, wherein the valve body has rotational movement relative to the valve seat when the actuation shaft is rotated.

6. The sprinkler of claim 1, wherein the valve seat is defined by a downstream end of the first flow tube.

7. The sprinkler of claim 6, wherein the valve seat is disposed within the second flow tube.

8. The sprinkler of claim 1, wherein the first flow tube and the second flow tube are two separate components that are coupled together.

9. The sprinkler of claim 1, wherein the first flow tube includes an upstream portion and a downstream valve portion, the valve portion comprising the valve seat.

10. The sprinkler of claim 9, wherein the valve portion has a reduced outer diameter relative to an outer diameter of the upstream portion and projects concentrically within the second flow tube.

11. The sprinkler of claim 1, wherein the valve seat comprises first and second helical surfaces and the valve plunger comprises corresponding first and second helical surfaces, wherein in the closed position the first and second helical surfaces of the valve seat and the first and second helical surfaces of the valve plunger contact one another to prevent flow of water past the valve seat.

12. The sprinkler of claim 11, wherein a downstream end of the first helical surface of the valve seat is adjacent to an upstream end of the second helical surface of the valve seat.

13. The sprinkler of claim 1, wherein the first flow tube is upstream of the second flow tube and coupled thereto, and the second flow tube includes an upstream portion and a downstream portion, the upstream portion having a larger diameter relative to the downstream portion.

14. A sprinkler, comprising:
a sprinkler body having an inlet and an exit for dispensing water from the sprinkler;
a cap connected to the sprinkler body;
a water passage within the sprinkler body that communicates water from the inlet to the exit; and
a valve disposed in the water passage for controlling water flow through the water passage, the valve comprising a valve seat and a plunger, the plunger comprising:
a first elongated shaft being rotatable and accessible through the cap of the sprinkler;
a second elongated shaft being operably coupled to the first elongated shaft and threadingly engaged in a threaded passage in the water passage to cause axial movement of the plunger relative to the valve seat when the first elongated shaft is rotated; and
a valve body disposed along one or both of the first elongated shaft and the second elongated shaft, the valve body movable relative to the valve seat to control water flow through the water passage when the first elongated shaft is rotated.

15. The sprinkler of claim 14, wherein the sprinkler body comprises a first flow tube and a second flow tube at least partially downstream of the first flow tube, wherein the valve seat is defined by an end of the first flow tube.

16. The sprinkler of claim 15, wherein the valve seat is disposed within the second flow tube.

17. The sprinkler of claim 15, wherein the threaded passage is within the first flow tube upstream of the valve seat.

18. The sprinkler of claim 14, wherein the valve body is positioned upstream of at least a portion of the first elongated shaft and downstream of at least a portion of the second elongated shaft.

19. The sprinkler of claim 14, wherein the valve body moves axially and rotationally relative to the valve seat when the shaft is rotated.

20. The sprinkler of claim 15, wherein the valve body and the valve seat have one or more corresponding helical surfaces that sealingly engage one another when the first elongated shaft is rotated to a closed position of the valve.

21. The sprinkler of claim 20, wherein the valve body has two helical surfaces that correspond to two corresponding helical surfaces of the valve seat, configured so that when the first elongated shaft is rotated to a position greater than 0° and less than or equal to 180° relative to the closed position, the helical surfaces of the valve body and the valve seat define two slots between the valve body and the valve seat for fluid to pass from an upstream side of the valve seat to a downstream side of the valve seat.

22. The sprinkler of claim 21, wherein the two helical surfaces of the valve body and the corresponding two helical surfaces of the valve seat are configured so that when the first elongated shaft is rotated to a position greater than 180° relative to the closed position, a single continuous slot is defined between the valve body and the valve seat for fluid to pass from an upstream side of the valve seat to a downstream side of the valve seat.
